(19) United States
(12) Patent Application Publication
(10) Pub. No.: US 2014/0280800 A1
(43) Pub. Date: Sep. 18, 2014

(54) APPARATUS AND METHOD TO MAINTAIN CONSISTENT OPERATIONAL STATES IN IN CLOUD-BASED INFRASTRUCTURES

(71) Applicants: Dominique G. VERCHERE, Breuillet (FR); Helia POUYLLAU, Les Ulis (FR)

(72) Inventors: Dominique G. VERCHERE, Breuillet (FR); Helia POUYLLAU, Les Ulis (FR)

(73) Assignee: Alcatel-Lucent Bell Labs France, Paris (FR)

(21) Appl. No.: 13/804,213

(22) Filed: Mar. 14, 2013

(51) Int. Cl. H04L 12/24

(52) U.S. Cl. CPC H04L 41/0813
USPC 709/221

(57) ABSTRACT

Various exemplary embodiments relate to a method and related device including: receiving, at the service correlator device, an incoming notification that an operational state of a first service element of a cloud service has changed; identifying a potential change to a second service element of the cloud service having a current operational state that is inconsistent with the operational state of the first service element, wherein effecting the potential change to the second service element would produce a new operational state of the second service element that is consistent with the operational state of the first service element; determining whether to notify other devices of the potential change to the second service element; and transmitting an outgoing notification to a management device responsible for managing the second service element based on determining to notify other devices, wherein the outgoing notification indicates the potential change to the management device.

### TECHNICAL FIELD

Various exemplary embodiments disclosed herein relate generally to cloud computing.

### BACKGROUND

Cloud-based services often involve combinations of different service elements. For example, a Virtual Data Center (VDC) may include a combination of virtual machines (VMs) and virtual networks (VNs) providing connectivity between the VMs. The different service elements for many such services can be managed by separate entities and organizations. In the case of a VDC, the VMs may be managed by a data center operator while the VNs may be managed by a network operator.

As the states of some service elements change for a cloud service, it may be desirable to effect complementary changes to other service elements for the cloud service to help make efficient use of resources. For example, in a VDC, if all VMs are suspended, it may be desirable to set the VNs to hibernate, thereby freeing resources for use by other services. Effecting complementary changes between differing service elements may be difficult to achieve, however, especially when the service elements are not all managed by a single entity or organization.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method performed by a service correlator device for changing an operational state for a cloud service, the method including: receiving, at the service correlator device, an incoming notification that an operational state of a first service element of a cloud service has changed; identifying a potential change to a second service element of the cloud service having a current operational state that is inconsistent with the operational state of the first service element, wherein effecting the potential change to the second service element would produce a new operational state of the second service element that is consistent with the operational state of the first service element; determining whether to notify other devices of the potential change to the second service element; and transmitting an outgoing notification to a management device responsible for managing the second service element based on determining to notify other devices, wherein the outgoing notification indicates the potential change to the management device.

Various exemplary embodiments relate to a service correlator device including: a memory; and a processor in communication with the memory, the processor being configured to: receive, at the service correlator device, an incoming notification that an operational state of a first service element of a cloud service has changed, identify a potential change to a second service element of the cloud service having a current operational state that is inconsistent with the operational state of the first service element, wherein effecting the potential change to the second service element would produce a new operational state of the second service element that is consistent with the operational state of the first service element, determine whether to notify other devices of the potential change to the second service element, and transmit an outgoing notification to a management device responsible for managing the second service element based on determining to notify other devices, wherein the outgoing notification indicates the potential change to the management device.

Various exemplary embodiments relate to a non-transitory machine-readable medium encoded with instructions for execution by a service correlator device for changing an operational state for a cloud service, the medium including: instructions for receiving, at the service correlator device, an incoming notification that an operational state of a first service element of a cloud service has changed; instructions for identifying a potential change to a second service element of the cloud service having a current operational state that is inconsistent with the operational state of the first service element, wherein effecting the potential change to the second service element would produce a new operational state of the second service element that is consistent with the operational state of the first service element; instructions for determining whether to notify other devices of the potential change to the second service element; and instructions for transmitting an outgoing notification to a management device responsible for managing the second service element based on determining to notify other devices, wherein the outgoing notification indicates the potential change to the management device.

Various embodiments are described wherein the first service element includes a virtual machine, the second service element includes a virtual network, and the management device includes at least one of: a network management system (NMS) and a customer edge router.

Various embodiments are described wherein the first service element includes a virtual network, the second service element includes a virtual machine, and the management device includes a hypervisor.

Various embodiments are described wherein identifying the potential change to the second service element includes: selecting a mapping rule from a set of externalized mapping rules that matches the operational state of the first service element, wherein the selected mapping rule identifies the potential change to the second service element.

Various embodiments are described wherein determining whether to notify other devices includes: waiting for a predetermined hold-off time to receive further incoming notifications; and determining to notify other devices based on expiration of the hold-off time without receiving further incoming notifications.

Various embodiments are described wherein determining whether to notify other devices includes: identifying a previous decision to notify other devices of the potential change to the second service element; determining whether the previous decision resulted in a successful service reconfiguration; and determining to notify other devices based on the previous decision resulting in successful service reconfiguration.

Various embodiments are described wherein transmitting an outgoing notification to a management device includes: identifying a first management device and a second management device; determining an order for sending outgoing notifications to the first management device and the second management device; and transmitting a first outgoing notification to the first management device and a second outgoing notification to the second management device according to the determined order.

Various embodiments additionally include changing an operational state of the cloud service to an In-Transition state based on receiving the incoming notification; receiving an indication from the management device that the potential change was performed; and changing an operational state of the cloud service to a different state based on receiving the indication.

### BRIEF DESCRIPTION OF THE DRAWINGS

In order to better understand various exemplary embodiments, reference is made to the accompanying drawings, wherein:

FIG. 1 illustrates an exemplary network for providing a cloud service;

FIG. 2 illustrates an exemplary network for maintaining a consistent operational state in a cloud service;

FIG. 3 illustrates an exemplary functional block diagram of a service correlator device;

FIG. 4 illustrates exemplary correspondences between cloud service operational states and service element states;

FIG. 5 illustrates an exemplary table for storing cloud service definitions;

FIG. 6 illustrates an exemplary table for storing cloud service mapping rules;

FIG. 7 illustrates an exemplary table for storing the results of previous decisions for a cloud service;

FIG. 8 illustrates an exemplary method for changing an operational state for a cloud service;

FIG. 9 illustrates an exemplary message flow in changing an operational state for a cloud service; and

FIG. 10 illustrates an exemplary hardware component diagram for a service correlator device.

To facilitate understanding, identical reference numerals have been used to designate elements having substantially the same or similar structure or substantially the same or similar function.

### DETAILED DESCRIPTION

The description and drawings illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

It will be understood that while various exemplary embodiments are described herein with relation to virtual data center (VDC) services including virtual machines (VMs) and virtual networks (VNs), the systems and methods described herein may be applied to any cloud services and constituent service elements.

In view of the foregoing, it may be desirable to provide a method or device that facilitates consistent state maintenance of various service elements associated with a cloud service. As such, a service correlator device will be described herein that may notify the varying maintenance systems of changes to service elements that would be effective in maintaining a consistent overall cloud service state.

Referring now to the drawings, in which like numerals refer to like components or steps, there are disclosed broad aspects of various exemplary embodiments.

FIG. 1 illustrates an exemplary network 100 for providing a cloud service. It will be understood that the network 100 may be in some respects a simplification; other networks may include numerous additional devices such as intermediate routers and switches, additional data centers, additional computers, additional storage systems and devices, or various management devices. As used herein, the term “management device” will be understood to encompass any device, or component thereof, configured to manage the operation or state of one or more service elements. As illustrated, the exemplary network includes four constituent networks: an enterprise network 110, two data center networks 120, 130, and a transport network.

The enterprise network 110 may be any network operated by a tenant of a cloud service. As such, the enterprise network 110 may include multiple end devices 114, 116, a customer edge router 112, and any other devices (not shown) that may be owned or operated locally by the tenant. The end devices 114, 116 may be configured to make use of a cloud service, such as a virtual data center (VDC), provided by the remaining networks 120, 130, 140. For example, the end devices 114, 116 may utilize processing or storage resources allocated to the enterprise network 110 within a VDC.

Data center 1 120 may include various hardware made accessible via a customer edge router. For example, data center 1 120 may include one or more computer farms 124, such as racks of server blades, to provide processing resources. Data center 1 120 may also include one or more storage systems 126 to provide access to various on-site storage devices 127, 128, 129. Data center 2 130 may include similar hardware such as customer edge routes 132, 133, computer farms 134, storage systems 136, and storage devices 137, 138, 139. It will be apparent that various embodiments may utilize data centers having additional or alternative sets of hardware resources. For example, a data center may include only computer farms or only storage systems. Further variations will be apparent.

The various hardware located on the data center networks 120, 130 may support virtual machines (VMs) that belong to VDCs. For example, the computer farms 124 in data center 1 120 may support two VMs: VM1 and VM2. Likewise, the computer farms 134 in data center 2 130 may support an additional VM: VM3. The storage systems 136 in data center 130 may also support a VM: VM4. VMs 1-4 may cooperate to provide a VDC service. For example, VMs 1-3 may provide processing resources while VM4 may provide access to mass storage to VMs 1-3 or end devices 114, 116.

The transport network 140 may include a number of provider edge routers 142, 144, 146, 148 and other intermediate routing devices (not shown) configured to enable data communications between the other networks 110, 120, 130. In various embodiments, the transport network 140 may include the Internet or portions thereof.

The various hardware belonging to the transport network 140 may be configured to support virtual networks (VNs) that belong to VDCs. For example, three of the provider edge devices 142, 144, 146 may be configured to support a VN 150 extending between the customer edge routers 112, 122, 132 of the other networks 110, 120, 130. Various methods of implementing a VN will be apparent. For example, the VN may constitute a virtual private network (VPN) such as a virtual LAN (VLAN) or a virtual private routed network (VPRN). As such, a management device, such as a network management system (NMS) may configure the provider edge routers 142, 144, 146 to recognize and forward traffic belonging to the VN 150 toward the appropriate customer edge routers 112, 122, 132. It will be apparent that various alternative management devices may be utilized such as, for example, one or more devices belonging to a control network that provisions VNs in lieu of a centralized NMS.

During operation of the VDC including VMs 1-4 and VN1 150, the states of the constituent service elements may change. For example, VM1 may be suspended by an operator, VM4 may be automatically relocated from the storage systems 136 of datacenter 130 to the storage systems 126 of data center 120, or a network failure in the transport network 140 may render the VN unavailable. The operation of some such service elements may be dependent on the availability of other service elements and, as such, it may be beneficial to make further changes to other service element states for resource savings. For example, if an operator suspends all VMs 1-4, the VN 150 may no longer perform any function because the enterprise network 110 has no remaining VMs with which to communicate. As such, it may be desirable to also suspend the VN until the VMs are reinstated. As noted, however, this form of cooperation may be difficult between different networks, especially when the networks are not managed by the same entities or organizations.

FIG. 2 illustrates an exemplary network 200 for maintaining a consistent operational state in a cloud service. It will be understood that the network 200 may be in some respects a simplification and may include additional devices such as intermediate routers and switches, additional data centers, additional computers, storage systems and devices, or additional management systems.

The network 200 includes two different networks for providing a cloud service such as a VDC: a data center network 210 and a transport network 230. In various embodiments, the data center network 210 may correspond to either data center network 120, 130 of exemplary network 100, while transport network 230 may correspond to the transport network 140 of exemplary network 100.

The data center network 210 may include a customer edge router 212 that provides network connectivity to one or more physical end computers 220 hosted at the data center. The computers 220 may include, for example, servers, blades, or any other computing system and may correspond to computer farms 124, 134, storage systems 126, 136, or other hardware that supports VMs. One or more of the computers may include a hypervisor 222 configured to establish and manage multiple VMs 224, 226, 228. The hypervisor 222 may include various interfaces for receiving commands regarding the VMs 224, 226, 228. For example the hypervisor 222 may receive instructions via a network interface from a cloud management system for the establishment, modification, or termination of VMs 224, 226, 228. As another example, the hypervisor 222 may receive similar instructions from a data center operator via a user interface.

The transport network 230 may include multiple provider edge routers 232, 234, 236, 238 that facilitate communication between various customer edge routers 212, 240, 242. The provider edge routers 232, 234, 236, 238 may correspond to the various provider edge routers 142, 144, 146, 148 of exemplary network 100. As noted above, the provider edge routers 232, 234, 236, 238 may be configured, together with the customer edge routers 212, 240, 242 to provide a VN service 255a-d. For example, the provider edge routers 232, 234, 236, and customer edge routers 212, 240, 242 may each be configured to establish a VPN therebetween. The provision of such VNs may be coordinated, at least in part, by a network management system (NMS) 250. The NMS 250 may configure such VN services by transmitting instructions to the provider edge routers 232, 234, 236, 238 and may monitor the health of the various links in the transport network 230.

To facilitate the maintenance of the VMs 224, 226, 228 and VN 255a-d in consistent states, the network 200 may include a VDC correlator device 260. The VDC correlator device 260 may include a server, blade, or any other suitable computing system. In various embodiments, the VDC correlator device 260 may be provisioned within the cloud such as, for example, on one or more of the computers 220 belonging to the data center 210. In some embodiments, the VDC correlator device 260 may be provisioned within a management device such as the hypervisor 222 or the NMS 250.

The VDC correlator 260 may receive notifications from the various management devices of the network 200 as the service elements belonging to the VDC change state. For example, the hypervisor 222 may notify the VDC correlator 260 whenever a VM 224, 226, 228 experiences a state change and the NMS 250 may notify the VDC correlator 260 whenever the VN 255a-d experiences a state change. As will be explained in greater detail below, upon receiving such a notification, the VDC correlator 260 may determine whether the state of any other service elements should be changed and, if so, send a sequence of notifications to the appropriate management devices indicating that such state changes should be effected. In this manner, the VDC correlator facilitates the various management systems 222, 250 in maintaining the VDC in an overall consistent state.

FIG. 3 illustrates an exemplary functional block diagram of a service correlator device 300. In various embodiments, the service correlator device 300 is a VDC correlator, such as the VDC correlator 260 of exemplary network 200. The VDC correlator may include three modules: an orchestration module 310, a mapping module 320, and a decision module 330. The orchestration module 310 may embed protocol interfaces to allow informing or synchronizing with the various management systems associated with various VDCs. The mapping module 320 may include correspondences between the various operational states of the service elements belonging to the VDC. The decision module 330 may make decisions as to whether to notify the various management systems of operational state changes. These high level functions may be provided by various subcomponents, as will now be described. It will be understood that the modules and subcomponents of the VDC correlator 300 may be implemented by hardware or machine-executable instructions.

The VDC services manager 312 may receive various definitions of VDC services. For example, a cloud management system or a human operator may provide an identification of the various VDCs and constituent VMs and VNs that are to be managed by the VDC correlator 300. Further, the VDC services manager 312 may provide such information upon request by other subcomponents such as the state change observer 316 or the orchestration generator 342. The VDC services manager may store the VDC definitions in a VDC services database 314. The VDC services database 314 may be a storage device configured to store various information describing VDC services. Exemplary contents for the VDC services database 314 will be described in greater detail below with respect to FIG. 5.

The state change observer 316 may receive the various notifications of changes to service element operational states from various management devices including, for example, hypervisors and network management systems. Such notifications may include an identifier for the associated VDC along with an indication of the changed operational states. The state change observer 316 may use the received VDC identifier request the VDC definition from the VDC services manager 312 and send this information, along with the state change notification, to the mapping algorithm 322 for processing.

The mapping algorithm 322 may determine, based on a reported state change, whether any additional state changes to other service elements would be appropriate for maintaining overall VDC operational state consistency. For example, the mapping algorithm 322 may access an externalized rule set stored in the mapping rules storage 324, identify an applicable rule based on the reported state change, and identify further appropriate state changes identified by the rule. The mapping rules storage 324 may be any storage device. In various embodiments, the mapping rules stored in the mapping rules storage 324 may be generalized to all VDCs, all VDCs of a specific class, or may be tailored to a specific instances of VDCs. In some embodiments, an operator of the VDC correlator 300 may define such rules or may define rule templates for all VDCs or VDCs of a specific class. In embodiments using rule templates, the VDC correlator 300 may instantiate the rule templates based on the VDC service definitions received by the VDC services manager 312. Exemplary mapping rules for storage in mapping rules storage 324 will be described in greater detail below with respect to FIG. 6. Upon receiving a notification of an operational state change and determining that further operational state changes may be appropriate, the mapping algorithm 322 may change the state of the associated VDC to an “In Transition” state to avoid an undefined state as the VDC transitions from one stable operating state to another.

After identifying one or more potentially appropriate changes, the mapping algorithm 322 may pass indications of the changes to the decision algorithm 332. The decision algorithm 332 may determine whether any management devices should actually be notified of the additional changes. Under various circumstances it may be desirable to delay or avoid notifications to other devices. For example, the state change observer 316 may in some situations receive a rapid succession of incoming notifications of changes. It may be undesirable to send an outgoing notification to the management devices after each such incoming notification. Accordingly, the decision algorithm 332 may implement a holdoff time. Specifically, the decision algorithm 332, on receiving a potential state change from the mapping algorithm 322, may wait for a predefined period of time before sending a notification. If no additional incoming notifications are received by the state change observer for the VDC, the decision algorithm may proceed to pass the potential state change along for notification to a management system. In various embodiments, the state change observer may report, for each VDC, a time since the last state change was observed or, alternatively, may notify the decision algorithm directly whenever a state change is observed. By waiting for the holdoff time rather than notifying other devices immediately based on an incoming notification, the decision algorithm may avoid undesirable effects associated with reacting to transient service element states such as, for example, inconsistent states between service elements and an instable overall operational state of the VDC.

As another example, the decision algorithm 332 may refrain from passing along potential state changes when previous notifications of similar state changes were unsuccessful or otherwise undesirable. Thus, the decision algorithm may refer to a past results storage 334 to determine whether any previous notifications match the current potential state change and, if so, what result followed from the notification. For example, if a management system has previously declined to implement a state change suggested in an outgoing notification, the decision algorithm 332 may refrain from sending a notification including the same suggested state change. As another example, if the decision algorithm 332 identifies a transient problem such as a link failure by locating past results that reverse a suggested state change in a relatively short time, the decision algorithm 332 may decline to report the suggested notification. In some situations, the mapping algorithm 322 may identify multiple potential state changes and the decision algorithm may approve and pass along only a subset of these potential state changes based on the past results 334. Exemplary contents for the past results storage 334 will be described in greater detail below with respect to FIG. 7.

After the decision algorithm 332 passes on a set of potential state changes, the orchestration generator 342 may determine which devices should receive an outgoing notification and in what order. The orchestration generator 342 may begin by requesting information regarding the VDC from the VDC services manager. This information may include indications of which management devices manage the various VMs and VNs belonging to the VDC. Then, using the rules stored in the organizational rules storage 344, may determine which notifications should be sent and in which order. These organizational rules may be provided by an operator of the VDC. In various embodiments, the organizational rules may a written in a high-level orchestration language, such as Orc. Alternatively, the organizational rules may be written in any model for correlation, synchronization, and parallelization such as, for example, one or more Petri nets. In some embodiments, after being written, the organizational rules may be translated into an implementation such as Business Process Execution Language (BPEL) or Yet Another Workflow Language (YAWL). The orchestration generator may then provide a high-level ordered list of notifications to the orchestration engine 346.

The orchestration engine 346 may translate the high level notifications to protocol-specific commands to be transmitted to the various management devices. For example, the orchestration engine may construct notifications according to protocols known to be understood by a hypervisor, NMS, customer edge router, or any other device that may manage a service element or an aspect thereof. In some embodiments, the notifications may be sent over a direct command interface, such as according to the Simple Network Management Protocol (SNMP). The orchestration engine 346 may send notifications in parallel with other notifications or may wait to receive acknowledgements for some notifications before transmitting additional notifications, as specified by the order determined by the orchestration generator 342.

Upon receiving various acknowledgements in response to outgoing notifications, the orchestration engine may pass such feedback to the feedback manager 352. The feedback manager 352, in turn, may pair the feedback with the notification previously sent and any other information. This data may be stored together in the past results storage 334 for future use by the decision algorithm.

FIG. 4 illustrates exemplary correspondences 400 between cloud service operational states and service element states. In various embodiments, the correspondences 400 may be embedded in a VDC correlator, such as in the mapping rules storage 324 or the operation of the VDC correlator 300 of FIG. 3.

As shown, each VDC state 410 may be associated with various operational states of its constituent VNs 420 and VMs 430. For example, correlation 440 may show that, when the constituent VNs and VMs all have a “Designed” operational state, the VDC may also be said to be in a “Designed” state. As another example, correlation 445 may indicate that the VDC is in a “Created” state when the constituent VNs are in a “Reserved” state and the VMs are each in either a “Created” or “Creating” state. The meanings of the correlations 450-480 will be apparent in view of the foregoing description.

Because the VDC states depend upon multiple underlying states, it is unlikely that the VDC state will instantaneously transition from one of the states defined by the correlations 440-480 to another. Instead, correlation 485 shows that, when the VN and VM states do not match the correlations 440-480, the VDC may be said to occupy an “In Transition” state, rather than being undefined. Further, correlation 490 shows that, if any of the VMs or VNs report errors, the VDC may also be said to occupy an “Error” state.

FIG. 5 illustrates an exemplary data arrangement 500 for storing cloud service definitions. The data arrangement 500 may describe the contents of the VDC services database 314 of FIG. 3. As shown, the data arrangement may include a VDC identification field 510, a VDC state field 520, a VMs field 530, and a VNs field 540. The VDC identification field 510 may store an identifier for each known VDC. The various management devices may include this identifier when reporting changes to operational states. The VDC state field 520 may store an overall operational state of the VDC which may be maintained by the VDC correlator 300. The VMs field 530 may store a list of VM identifiers that correspond to the VDC. In various embodiments, the VMs field 530 may also store an indication of the operational state of each such VM. Likewise, the VNs field 540 may store an identifier for each VN that belongs to the VDC and a current operational state for each VN.

As an example, record 550 shows that VDC “0” is currently “Activated” and is associated with VMs1-4, which are all “Running,” and VN1, which is “Activated.” As another example, record 560 shows that VDC “1” is currently “Suspended” and is associated with VMs5-6 which are “Suspended,” VM7 which is “Suspending,” and VNs2-3 which are “Hibernating.” As yet another example, record 570 shows that VDC “2” is currently “In Transition” and is associated with VM8, which is “Deleting,” VM9, which is “Running,” and VN4, which is “Activated.” The data arrangement may include numerous additional records 580.

It will be understood that while various information is illustrated as composing a VDC definition, additional or alternative information may be present. For example, each VM and VN may be associated with one or more management devices that are to be contacted if a potential change to the respective VM or VN is to be reported.

FIG. 6 illustrates an exemplary data arrangement 600 for storing cloud service mapping rules. The data arrangement 600 may describe the contents of the mapping rules storage 324 of FIG. 3. Specifically, the data arrangement 600 may show a set of mapping rules related to a VDC “0,” such as the VDC described by record 560 of the data arrangement 500 described in FIG. 5. In various alternative embodiments, the mapping rules in data arrangement 600 may be generalized to all cloud services, all VDCs, or all VDCs of a specific class.

As shown, the mapping rules may include a VMs field 610 and the VNs field 620. The VMs field 610 may identify a change or group of changes to operational states of VMs belonging to the associated VDC 0. Likewise, the VNs field 620 may identify a change or group of changes to operational states of VMs belonging to the associated VDC 0. In various embodiments, the application of the rules defined in data arrangement 600 may depend on the priority the VDC correlator 300 affords to the different service elements. If the VMs take priority over the VNs, the VMs field 610 may define the criteria for rule application while the VNs field 620 may define the result of the rule application. In other words, if the state changes described in the VMs field 610 are observed, then the state changes described in the VNs field 620 may potentially be notified to the appropriate management systems. If, on the other hand, the VNs take priority over VMs, the VNs field 620 may be taken as a criteria field while the VMs field 610 may be taken as a result field. As yet another alternative, the prioritization may be set somewhere between the two extremes described above. For example, both fields 610, 620 may be taken as both criteria and results fields. Thus, if the states defined in either field 610, 620 are observed by the VDC correlator, the VDC correlator may notify the appropriate management device of the changes in the opposite field 610, 620. With respect to the following description, a VDC that places VMs as having priority over VNs will be described; however, the variations in operation according to other priority schemes or settings will be apparent.

Exemplary rule 630 indicates that if VMs 1-4 are reported as “Suspending” then VN1 could potentially be set to “Hibernating.” Such a rule may be configured to bring the overall VDC state to a “Suspended” state, as described by correlation 465 in FIG. 4. As another example, rule 640 may indicate that if VMs 1-2 are reported as stopping, while VMs 3-4 remain running, VN1 may potentially be terminated. The state changes described in the various rules 630-660 may be more complex than simple indications of state change and, instead, may include specific parameters or other data that may be reported to the various management systems. For example, exemplary rule 650 may indicated that if VM1 is suspended while VMs 2-4 remain running, VN1 may be modified to reduce available bandwidth by 50%. Various other data to include in a mapping rule will be apparent. The data arrangement 600 may include numerous additional mapping rules 660.

FIG. 7 illustrates an exemplary data arrangement 700 for storing the results of previous decisions for a cloud service. The data arrangement may describe the contents of the past results storage 334 of FIG. 3. As illustrated, the exemplary data arrangement may correspond to decisions relating to VDC “0” such as the VDC described by record 560 of the data arrangement 500 described in FIG. 5. In various alternative embodiments, the results in data arrangement 700 may be generalized to all cloud services, all VDCs, or all VDCs of a specific class.

As shown, each result record may include a timestamp field 710, a decision field 720, and a result field 730. The timestamp field 710 may include a timestamp indicating when a past decision was made or when a result for a past decision was received. The decision field 720 may identify a decision that was previously made such as the proposed state change that the decision algorithm 332 decided to report. The result field 730 may indicate a result of such a decision, such as an acknowledgement received from a management device or a metric reflecting a change in performance due to the previous decision. Various alternative or additional fields for use in evaluating past decisions will be apparent.

As an example, the result record 740 indicates that, at time “1364406364” a decision was made to send a notification suggesting that the bandwidth for VN1 be reduced to 50% of current capacity. Result record 740 may also indicate that one or more of the relevant management devices, such as an NMS or customer edge router, may have reported that the suggested change was not implemented. As another example, the result record 750 indicates that at time “1363909821,” the decision was made to notify the management devices to set VN1 to hibernate. The result record 750 may also indicate that the relevant management devices acknowledged this notification, indicating that the VN1 was set to hibernate as suggested. The data arrangement 700 may include numerous additional result records 760.

In various embodiments, a VDC correlator may periodically clean up the previous decisions stored in a data arrangement such as data arrangement 700. For example, a VDC correlator may periodically delete any previous decisions having a timestamp indicating that the decision is older than a predetermined aged. Alternatively, the timestamp filed 710, or a updated timestamp field (not shown), may be updated whenever a previous decision is utilized by the VDC correlator. In such an embodiment, the VDC correlator may determine that previous decisions that have not been used within a predetermined, preceding time period should be removed. Various modification will be apparent.

FIG. 8 illustrates en exemplary method 800 for changing an operational state for a cloud service. The method 800 may be performed by the components of a VDC correlator such as, for example, the orchestration module 310, the mapping module 320, and the decision module 330 of the VDC correlator 300 described in FIG. 3.

The method 800 may begin in step 805 and proceed to step 810 where the VDC correlator may receive a notification that one or more service elements associated with a VDC has experienced a state change. Then, in step 815, the VDC correlator may update the overall VDC state based on the new state of the service elements. Next, the VDC correlator may begin determining whether to notify any other devices by attempting to identify a mapping rule that matches the change observed in step 810. For example, the VDC correlator may evaluate each mapping rule relevant to the VDC (including any VDC-specific or generalized mapping rules) to determine whether any of the operational states listed in the rules match the reported states. In step 825, the VDC correlator may determine whether any matching rule has been found. If not, the method 800 may proceed to end in step 855.

If, on the other hand, an applicable mapping rule was located, the method 800 may proceed from step 825 to step 830, where the VDC correlator may determine the potential actions, such as state changes, that are also associated with the mapping rule. For example, if the state change received in step 810 related to VMs, the VDC correlator may pull any VN state changes listed in the applicable rule. Next, the VDC correlator may begin to make the decision of whether or not to report the potential actions in step 835 by locating any previous results associated with previous decisions to report the potential actions. In step 840, the VDC correlator may use any such located previous results and determine whether or not to send a notification. In various embodiments, step 840 may also include waiting for a predetermined holdoff period before proceeding with the method 800. In some embodiments, step 840 may also involve, for a set of potential actions, deciding to report some, but not all, potential actions in the set. If no notifications are to be sent, the method 800 may proceed to end in step 860.

If one or more notifications are to be sent, the VDC correlator may, in step 845, determine an order of notifications. For each potential action, multiple notifications might be sent. For example, a change to a VN may include notifications to an NMS and multiple customer edge routers. In step 845, the VDC correlator may determine what in what order such multiple notifications should be transmitted. For example, the VDC correlator may decide to notify the NMS first and then, after receiving an acknowledgement, notify all relevant customer edge routers in parallel. In step 850, the VDC correlator may proceed to construct protocol-specific notifications, as appropriate to each of the management devices that are to be notified. Finally, the VDC correlator may send these notifications in the determined order in step 855 and the method 800 may proceed to end in step 860.

FIG. 9 illustrates an exemplary message flow 900 in changing an operational state for a cloud service. The message flow 900 may involve multiple VMs 905, a hypervisor 910 that manages the VMs 905, a VDC correlator 915, an NMS 920, and a VN 925. An exemplary operation of a cloud services system incorporating the VDC correlator 915 will now be described with respect to a VDC 0 as described by record 550 of FIG. 5.

At the beginning of the message flow 900, the VDC 0 may be in n “Activated” operational state 930. While in the Activated state 930, an operator of the hypervisor 910 may decide to suspend VM1 and transmit a message 935 to the VMs 905 that VM1 should be suspended. Thereafter, the hypervisor 910 may notify the VDC correlator that VM1's operational state has changed to “Suspending.” The VDC correlator may process this notification by placing the VDC 0 in an “In Transition” state and, in process 945, deciding not to send any further notifications. For example, based on rule 950, the VDC correlator may decide that the potential action to take in response to suspending the VM1 would be to modify the bandwidth of VN1 to 50% of current capacity. However, the VDC correlator may decide not to send any such notification to the NMS 920 based on the NMS's previous refusal to take such action, as recorded in previous result 740.

At some time in the future, the hypervisor 910 may send a message 950 to the VMs indicating that VMs 2-4 should also be suspended and, then, may send a message notifying the VDC correlator 915 that the states of VMs 2-4 have also changed to suspending. In process 960, the VDC correlator may decide to notify the NMS 920 to hibernate VN1 based on mapping rule 630 and past result record 750. Thus, the VDC correlator 915 may send a protocol-specific message 965 to the NMS 920 suggesting or instructing the NMS 920 to hibernate the VN 925. The NMS 920 may issue such an instruction 970 to the VN 925 which, in turn, may send an acknowledgement 975 back to the NMS of successful suspension. Finally, the NMS 920 may report the state change of the VN 925 to “Hibernating” and the VDC correlator 915 may change the state of the VDC 0 from “In Transition” to “Suspended.” The VDC correlator 915 may also store an indication of successful hibernation for future reference.

Various alternative message flows will be apparent. For example, the VN 925 may report a link failure which, in turn, may prompt the VDC correlator 915 to suggest that the hypervisor 910 stop the VMs 905. This message flow may be possible in VDC correlator 915 systems that give the VN 925 priority, at least in some situations, over the VMs 905.

FIG. 10 illustrates an exemplary hardware component diagram for a service correlator device 1000. The service correlator device 1000 may correspond to a VDC correlator such as VDC correlators 260, 300, 915 described herein. The service correlator device 1000 may include a processor 1010, a data storage 1020, and an input/output (I/O) interface 1030.

The processor 1010 may control the various operations of the service correlator device 1000 and cooperate with the data storage 1020 and the I/O interface 1030, via a system bus. As used herein, the term “processor” will be understood to encompass a variety of devices such as microprocessors, field-programmable gate arrays (FPGAs), application-specific integrated circuits (ASICs), and other similar processing devices.

The data storage 1020 may store program data such as various programs useful in implementing the functions described above. For example, the data storage 1020 may store a mapping module instructions 1021, decision module instructions 1022, and orchestration module instructions 1023 for implementing the various functions described in connection with the mapping module 320, decision module 330, and orchestration module 310, respectively and as described above. Further, the data storage 1020 may also include a VDC services database 1024, mapping rules 1025, past results 1026, and organizational rules 1027, thereby storing the information described above with respect to the VDC services database 314, mapping rules storage 324, past results storage 334, and organizational rules storage 344.

The I/O interface 1030 may cooperate with the processor 1010 to support communications over one or more communication channels. For example, the I/O interface 1010 may include a user interface, such as a keyboard and monitor, and/or a network interface, such as one or more Ethernet ports.

In some embodiments, the processor 1010 may include resources such as processors/CPU cores, the I/O interface 1030 may include any suitable network interfaces, or the data storage 1020 may include memory or storage devices such as magnetic storage, flash memory, random access memory, read only memory, or any other suitable memory or storage device. Moreover the service correlator device 1000 may be any suitable physical hardware configuration such as: one or more server(s), blades including components such as processor, memory, network interfaces or storage devices. In some embodiments, the service correlator device 1000 may be provisioned within a cloud computing system. In such embodiments, one or more of the hardware components 1010, 1020, 1030 of the service correlator device 1000 may be distributed among multiple computer systems.

According to the foregoing, various embodiments enable the maintenance of cloud-based services, and their constituent service elements, in consistent operational states. By monitoring the operational states of constituent service elements, such as VMs and VNs, a service correlator device may send notifications to various management devices in order to suggest or command various changes to maintain a consistent overall VDC state and free unused resources. Additional benefits will be apparent in view of the foregoing.

It should be apparent from the foregoing description that various exemplary embodiments of the invention may be implemented in hardware or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a tangible and non-transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method performed by a service correlator device for changing an operational state for a cloud service, the method comprising:
receiving, at the service correlator device, an incoming notification that an operational state of a first service element of a cloud service has changed;
identifying a potential change to a second service element of the cloud service having a current operational state that is inconsistent with the operational state of the first service element, wherein effecting the potential change to the second service element would produce a new operational state of the second service element that is consistent with the operational state of the first service element;
determining whether to notify other devices of the potential change to the second service element; and
transmitting an outgoing notification to a management device responsible for managing the second service element based on determining to notify other devices, wherein the outgoing notification indicates the potential change to the management device.

2. The method of claim 1, wherein:
the first service element comprises a virtual machine,
the second service element comprises a virtual network, and
the management device comprises at least one of: a network management system (NMS) and a customer edge router.

3. The method of claim 1, wherein:
the first service element comprises a virtual network,
the second service element comprises a virtual machine, and
the management device comprises a hypervisor.

4. The method of claim 1, wherein identifying the potential change to the second service element comprises:
selecting a mapping rule from a set of externalized mapping rules that matches the operational state of the first service element, wherein the selected mapping rule identifies the potential change to the second service element.

5. The method of claim 1, wherein determining whether to notify other devices comprises:
waiting for a predetermined hold-off time to receive further incoming notifications; and
determining to notify other devices based on expiration of the hold-off time without receiving further incoming notifications.

6. The method of claim 1, wherein determining whether to notify other devices comprises:
identifying a previous decision to notify other devices of the potential change to the second service element;
determining whether the previous decision resulted in a successful service reconfiguration; and
determining to notify other devices based on the previous decision resulting in successful service reconfiguration.

7. The method of claim 1, wherein transmitting an outgoing notification to a management device comprises:
identifying a first management device and a second management device;
determining an order for sending outgoing notifications to the first management device and the second management device; and
transmitting a first outgoing notification to the first management device and a second outgoing notification to the second management device according to the determined order.

8. The method of claim 1, further comprising:
changing an operational state of the cloud service to an In-Transition state based on receiving the incoming notification;
receiving an indication from the management device that the potential change was performed; and
changing an operational state of the cloud service to a different state based on receiving the indication.

9. A service correlator device comprising:
a memory; and
a processor in communication with the memory, the processor being configured to:
receive, at the service correlator device, an incoming notification that an operational state of a first service element of a cloud service has changed,
identify a potential change to a second service element of the cloud service having a current operational state that is inconsistent with the operational state of the first service element, wherein effecting the potential change to the second service element would produce a new operational state of the second service element that is consistent with the operational state of the first service element,
determine whether to notify other devices of the potential change to the second service element, and
transmit an outgoing notification to a management device responsible for managing the second service element based on determining to notify other devices, wherein the outgoing notification indicates the identified potential change to the management device.

10. The service correlator device of claim 9, wherein:
the first service element comprises a virtual machine,
the second service element comprises a virtual network, and
the management device comprises at least one of: a network management system (NMS) and a customer edge router.

11. The service correlator device of claim 9, wherein:
the first service element comprises a virtual network,
the second service element comprises a virtual machine, and
the management device comprises a hypervisor.

12. The service correlator device of claim 9, wherein, in identifying the potential change to the second service element, the processor is configured to:
select a mapping rule from a set of externalized mapping rules that matches the operational state of the first service element, wherein the selected mapping rule identifies the potential change to the second service element.

13. The service correlator device of claim 9, wherein, in determining whether to notify other devices, the processor is configured to:
wait for a predetermined hold-off time to receive further incoming notifications; and
determine to notify other devices based on expiration of the hold-off time without receiving further incoming notifications.

14. The service correlator device of claim 9, wherein, in determining whether to notify other devices the processor is configured to:
identify a previous decision to notify other devices of the potential change to the second service element;
determine whether the previous decision resulted in a successful service reconfiguration; and
determine to notify other devices based on the previous decision resulting in successful service reconfiguration.

15. The service correlator device of claim 9, wherein, in transmitting an outgoing notification to a management device, the processor is configured to:
identify a first management device and a second management device;
determine an order for sending outgoing notifications to the first management device and the second management device; and
transmit a first outgoing notification to the first management device and a second outgoing notification to the second management device according to the determined order.

16. The service correlator device of claim 9, wherein the processor is further configured to:
change an operational state of the cloud service to an In-Transition state based on receiving the incoming notification;
receive an indication from the management device that the potential change was performed; and
change an operational state of the cloud service to a different state based on receiving the indication.

17. A non-transitory machine-readable medium encoded with instructions for execution by a service correlator device for changing an operational state for a cloud service, the medium comprising:
instructions for receiving, at the service correlator device, an incoming notification that an operational state of a first service element of a cloud service has changed;
instructions for identifying a potential change to a second service element of the cloud service having a current operational state that is inconsistent with the operational state of the first service element, wherein effecting the potential change to the second service element would produce a new operational state of the second service element that is consistent with the operational state of the first service element;
instructions for determining whether to notify other devices of the potential change to the second service element; and
instructions for transmitting an outgoing notification to a management device responsible for managing the second service element based on determining to notify other devices, wherein the outgoing notification indicates the identified potential change to the management device.

18. The non-transitory machine-readable medium of claim 17, wherein identifying the potential change to the second service element comprises:
instructions for selecting a mapping rule from a set of externalized mapping rules that matches the operational state of the first service element, wherein the selected mapping rule identifies the potential change to the second service element.

19. The non-transitory machine-readable medium of claim 17, wherein determining whether to notify other devices comprises:
instructions for identifying a previous decision to notify other devices of the potential change to the second service element;
instructions for determining whether the previous decision resulted in a successful service reconfiguration; and
instructions for determining to notify other devices based on the previous decision resulting in successful service reconfiguration.

20. The non-transitory machine-readable medium of claim 17, wherein transmitting an outgoing notification to a management device comprises:
instructions for identifying a first management device and a second management device;
instructions for determining an order for sending outgoing notifications to the first management device and the second management device; and
instructions for transmitting a first outgoing notification to the first management device and a second outgoing notification to the second management device according to the determined order.
